(19) United States
(12) Patent Application Publication
(10) Pub. No.: US 2026/0216728 A1
(43) Pub. Date: Jul. 30, 2026

(54) PARTICLE SEPARATION DEVICE AND PARTICLE SEPARATION METHOD

(71) Applicant: INDUSTRY-UNIVERSITY COOPERATION FOUNDATION HANYANG UNIVERSITY ERICA CAMPUS, Ansan-si (KR)

(72) Inventors: Jong Wook HONG, Seoul (KR); Kyu Soon SHIN, Anyang-si (KR)

(21) Appl. No.: 19/143,477

(22) PCT Filed: Dec. 26, 2023
(86) PCT No.: PCT/KR2023/021583

§ 371 Date: Jun. 26, 2025

(30) Foreign Application Priority Data
Dec. 26, 2022 (KR) 10-2022-0184137
Dec. 28, 2022 (KR) 10-2022-0186521
Dec. 28, 2022 (KR) 10-2022-0186522

(51) Int. Cl. B01L 3/00

(52) U.S. Cl. CPC B01L 3/502761; B01L 2200/0652; B01L 2300/0816; B01L 2300/0864; B01L 2300/0867

(57) ABSTRACT

The present invention relates to a particle separation device and a particle separation method, which can minimize damage to particles during particle separation process and enable separation of particles according to their size without using complex devices. The present invention provides the particle separation device including: t inflow path through which a first fluid including a plurality of particles of different sizes is introduced; a second inflow path through which a second fluid not including the particles is introduced; a connecting flow path of which one end is connected to the first inflow path and the second inflow path such that a third fluid in which the first fluid and the second fluid are mixed moves therein; a plurality of discharge paths through which the plurality of particles exiting through the other end of the connecting flow path are separated and discharged according to their sizes; and a branch flow path through which at least a part of the third fluid exiting through the other end of the connecting flow path is discharged, wherein the sum of the widths of the plurality of discharge paths is 500 to 1000 μm.

### TECHNICAL FIELD

The present invention relates to a particle separation device and a particle separation method, and more specifically, to a particle separation device and a particle separation method which can minimize damage to particles during the particle separation process and enable separation of particles according to their size without using complex devices.

### BACKGROUND ART

Particulate matter has a great impact on the human body and the earth's environment through various forms and routes. Its importance is also gradually being highlighted as related industries develop and interest in the environment increases. From measuring various molecules that can obtain bioinformation in living fluids to discovering low-concentration environmental substances distributed in the air, the molecules that affect us are diverse in size and concentration. In order to efficiently measure and analyze them, various sensors and reactors have been developed.

These sensors and reactors are designed to operate in a state of being separated from other substances within a specific concentration range. The sensors and reactors can perform stable analysis through a preprocessing process of separating and concentrating particles and molecules to a desired level. The preprocessing process mainly includes a process of separating substances according to their size, density, and charge, and concentrating the concentration of the substances within a measurable concentration range. The preprocessing process requires a certain level of advanced equipment and skilled personnel.

In addition, the separation process is generally a temporary separation based on the difference in the mobility of the material. In order to maintain a high degree of separation, the process of minimizing dispersion and diffusion by minimizing the working time and isolating the separated molecules follows. This is because dispersion and diffusion progress as time passes in the process, and to compensate for this, methods are being proposed to increase the concentration before separation so that a concentration higher than necessary can be maintained even after separation.

In addition, as the demand for diagnosis and synthesis using minute quantities of substances has increased recently, the demand for microscale systems such as lab-on-a-chip is also increasing. The technology for separating and controlling minute quantities of substances is very important, especially in the medical, chemical, and biological fields.

Lab-on-a-chip refers to a laboratory within a chip or a laboratory on a chip. It is developed to enable rapid performance of existing experiments research processes by creating microchannels smaller than nanoliters in a substrate mainly made of glass, polymer resin, silicon, etc., and moving liquid samples of several nanoliters through the microchannels.

Based on this lab-on-a-chip technology, a particle separation system that separates small amounts of particles with high precision is being studied. This particle separation technology using a lab-on-a-chip can separate small amounts of particles and maintain the separated particles at a high concentration, so it is widely used for preprocessing of other lab-on-a-chips or separation of particles entering sensors. However, conventional lab-on-a-chip particle separation systems have complex structures and complex separation mechanisms, and have limitations in low separation precision.

In addition, there are cases where the structure of particles separated through the particle separation system becomes disrupted and loses its function after separation.

Therefore, a particle separation device that has a simple structure but can minimize damage to particles is needed.

### DISCLOSURE

### Technical Problem

In order to solve the above-mentioned problem, the present invention aims to provide a particle separation device and a particle separation method capable of minimizing damage to particles during the particle separation process and separating particles according to their size without using complex devices.

### Technical Solution

To solve the above-described problem, the present invention provides a particle separation device including: an inflow path through which one or more types of fluids are introduced; a plurality of discharge paths through which a plurality of particles included in the fluid introduced through the inflow path are separated and discharged according to their sizes; and a branch flow path through which a portion of the one or more types of fluids is discharged, wherein the discharge path formed close to the inflow path based on the movement amount of the fluid discharges particles of relatively small sizes, and the discharge path formed far from the inflow path discharges particles of relatively large sizes.

In one embodiment, the particle separation device may have a hydraulic resistance (R) of 6 to 10 E+12 Ns/m⁵, as expressed by the following Equation 1.

$$R = \frac{1}{1 - 0.63 ( \frac{h}{w} )} * \frac{12 μ L}{{h}^{3} w} \qquad [ Equation 1 ]$$

(wherein, R represents the hydraulic resistance, h represents the height of the discharge path, w represents the sum of the widths of the discharge paths, u represents the dynamic viscosity of the first fluid, and L represents the length of the path through which the particle passes, respectively.)

In one embodiment, the sum of the widths of the plurality of discharge paths may be 500 to 1100 μm.

In one embodiment, the inflow path may be composed of: a first inflow path through which a plurality of particles of different sizes from the first flow are mixed and introduced; a second inflow path through which a second fluid not including the particles is introduced; and a connecting flow path between the inflow path and the discharge path, in which the first inflow path and the second inflow path are connected at one end and the other end is connected to the discharge path, and through which the third fluid composed of the first fluid and the second fluid moves.

In one embodiment, the connecting flow path may include: a substrate; a first side formed on the substrate and connected to the first inflow path; and a second side facing the first side on the substrate and connected to the second inflow path.

In one embodiment, the plurality of particles may be moved by sliding on the first side.

In one embodiment, the first side may be inclined toward the second side with respect to the substrate.

In one embodiment, the first side may have a flat shape, a step shape, or an arch shape.

In one embodiment, the plurality of discharge paths may be spaced apart from each other on the other end side of the connecting flow path in a direction intersecting with the flow direction of the third fluid.

In one embodiment, the flow rate ratio of the first fluid and the second fluid flowing into the first inflow path and the second inflow path, respectively, may be 0.1:99.9 to 50:50.

In one embodiment, the flow rate of the third fluid discharged through the branch flow path may be 0% to 99.9% of the flow rate of the third fluid discharged through the connecting flow path.

In one embodiment, the second inflow path may be inclined at a predetermined angle with respect to the first inflow path.

In addition, the present invention provides a particle separation device including: an inflow path through which one or more types of fluids are introduced; a plurality of discharge paths through which a plurality of particles included in the fluid introduced through the inflow path are separated and discharged according to their sizes; and a branch flow path through which a portion of the one or more types of fluids is discharged, wherein the particle separation device has a hydraulic resistance (R) of 6 to 10 E+12 Ns/m⁵, as expressed by the following Equation 1.

$$R = \frac{1}{1 - 0.63 ( \frac{h}{w} )} * \frac{12 μ L}{{h}^{3} w} \qquad [ Equation 1 ]$$

(wherein, R represents the hydraulic resistance, h represents the height of the discharge path, w represents the sum of the widths of the discharge paths, u represents the dynamic viscosity of the first fluid, and L represents the length of the path through which the particle passes, respectively.)

In addition, the present invention provides a particle separation method by size using a particle separation device, wherein the particle separation device includes: an inflow path through which one or more types of fluids are introduced; a plurality of discharge paths through which a plurality of particles included in the fluid introduced through the inflow path are separated and discharged according to their sizes; and a branch flow path through which a portion of the one or more types of fluids are discharged, wherein the discharge path formed close to the inflow path based on the movement amount of the fluid discharges particles of relatively small sizes, and the discharge path formed far from the inflow path discharges particles of relatively large sizes.

In one embodiment, the particle separation method may include the following steps of: supplying particles and a first fluid mixture through the first path among the inflow paths; supplying a second fluid through the second path among the inflow paths; discharging particles separated by size through the discharge path, respectively; and discharging excess fluid through the branch flow path.

### Advantageous Effects

The particle separation device and particle separation method according to the present invention can separate particles of different sizes according to particle size. According to the particle separation device particle separation method according to this embodiment, micro particles and nano particles can be separated from each other, and nano particles of different sizes can also be separated from each other.

Additionally, by minimizing the use of physical, chemical, and electrical energies, the particles can be prevented from being damaged during the separation process.

In addition, the particle separation device and particle separation method of this embodiment can separate semiconductor nanoparticles, bio nanoparticles, and nanoparticles such as blood, cord blood, exosomes, and fine dust.

### DESCRIPTION OF DRAWINGS

FIG. 1 illustrates a photograph of a particle separation device according to an embodiment of the present invention.

FIG. 2 is a plan view of a particle separation device according to an embodiment of the present invention.

FIG. 3 is a drawing explaining the process of separating particles passing through a connecting flow path according to an embodiment of the present invention.

FIG. 4 is a cross-sectional view of a connecting flow path cut along III-III of FIG. 2 according to an embodiment of the present invention.

FIG. 5 is a first modified example of the connecting flow path of FIG. 3 according to an embodiment of the present invention.

FIG. 6 is a second modified example of the connecting flow path of FIG. 3 according to an embodiment of the present invention.

FIG. 7 is a third modified example of the connecting flow path of FIG. 3 according to an embodiment of the present invention.

FIG. 8 is a drawing illustrating the degree of particle separation according to the change in flow rate of a branch flow path according to an embodiment of the present invention.

FIG. 9 is a photograph illustrating actual particle separation of a particle separation device having three discharge paths according to an embodiment of the present invention.

FIG. 10 is a photograph illustrating actual particle separation of a particle separation device having nine discharge paths according to an embodiment of the present invention.

FIG. 11 illustrates the simulation results of a particle separation device having three discharge paths according to one embodiment of the present invention.

FIG. 12 illustrates the simulation results of a particle separation device having nine discharge paths according to an embodiment of the present invention.

FIG. 13 is a simulation result of particle separation patterns according to the number of discharge paths by an embodiment of the present invention.

FIG. 14 is a simulation result of particle separation patterns by the difference in the sum of discharge path widths according to an embodiment of the present invention.

FIG. 15 illustrates the particle separation ratio results by one embodiment of the present invention.

FIG. 16 is a schematic diagram illustrating various methods of collecting saliva and isolating exosomes from saliva according to an embodiment of the present invention.

FIG. 17 is the results of exosome separation from saliva according to an embodiment of the present invention.

FIG. 18 is the result of peptide separation from saliva according to an embodiment of the present invention.

FIG. 19 is a schematic diagram illustrating a method for separating particles from urine according to an embodiment of the present invention.

FIG. 20 illustrates the results of exosome isolation from normal subjects, glomerulonephritis patients, and preeclampsia patients according to an embodiment of the present invention.

FIG. 21 illustrates the results of exosome isolation from a patient with preeclampsia according to an embodiment of the present invention according to each isolation method.

### BEST MODE

Hereinafter, preferred embodiments of the present invention will be described in detail. In describing the present invention, if it is determined that a detailed description of a related known technology may obscure the gist of the present invention, the detailed description will be omitted. Throughout the specification, singular expressions should be understood to include plural expressions unless the context clearly indicates otherwise, and the term such as “comprise” or “have” should be understood to specify that a described feature, number, step, operation, component, part or combination thereof exists, but does not exclude in advance the possibility of the existence or addition of one or more other features, numbers, steps, operations, components, parts or combinations thereof. In addition, in performing the method or manufacturing method, each process constituting the method may occur in a different order from the stated order unless the context clearly states a specific order. That is, each process may occur in the same order as the stated order, may also be performed substantially simultaneously, or may be performed in the opposite order.

The technology disclosed in this specification is not limited to the implementation examples described herein and may be embodied in other forms. However, the implementation examples introduced herein are provided so that the disclosed content can be thorough and complete and so that the technical idea of the technology can be sufficiently conveyed to those skilled in the art. In order to clearly express the components of each device in the drawings, the sizes of the components, such as width and thickness, are somewhat enlarged. In the overall description of the drawings, the description is made from the observer's point of view, and when an element is mentioned as being positioned on another element, this includes all the meaning that the one element is positioned directly on the other element or that additional elements may be interposed between the elements. In addition, a person skilled in the art will be able to implement the idea of the present invention in various other forms without departing from the technical idea of the present invention. In addition, the same reference numerals in multiple drawings indicate substantially the same elements.

As used herein, the term ‘and/or’ includes any combination of multiple listed items or any one of multiple listed items. As used herein, ‘A or B’ can include ‘A’, ‘B’, or ‘both A and B’.

The present invention relates to a particle separation device including: an inflow path through which one or more types of fluids are introduced; a plurality of discharge paths through which a plurality of particles included in the fluid introduced through the inflow path are separated and discharged according to their sizes; and a branch flow path through which a portion of the one or more types of fluids are discharged, wherein the discharge path formed close to the inflow path based on the movement amount of the fluid discharges particles of relatively small sizes, and the discharge path formed far from the inflow path discharges particles of relatively large sizes.

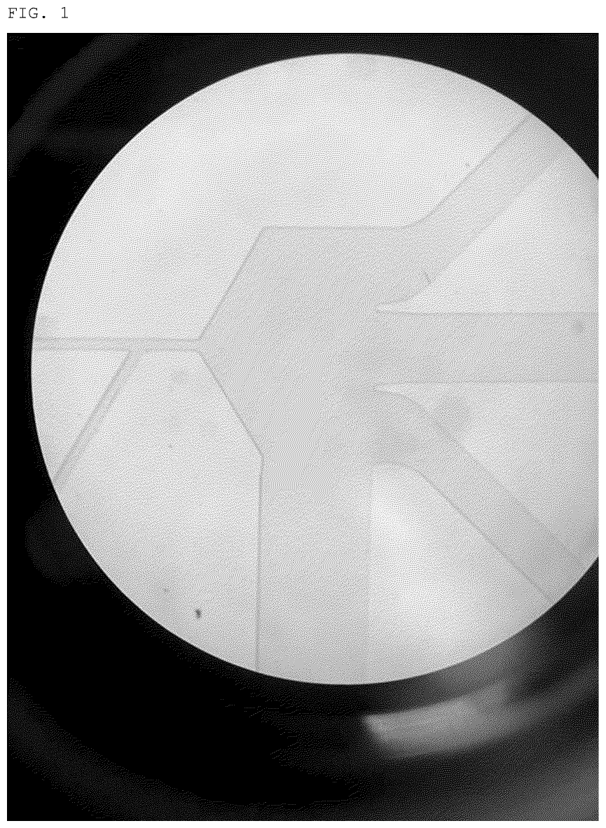

Hereinafter, the particle separation device according to an embodiment of the present invention will be described with reference to FIGS. 1 to 4.

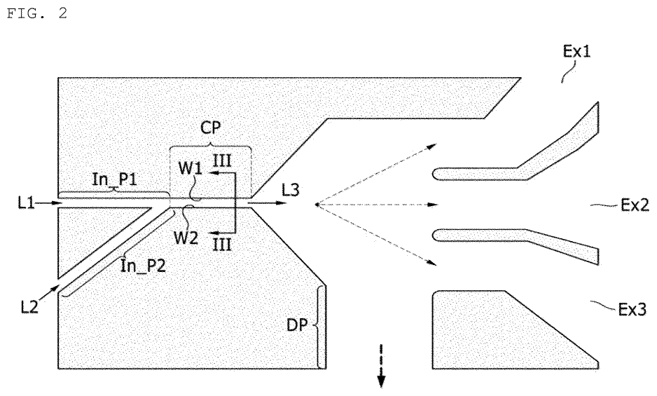

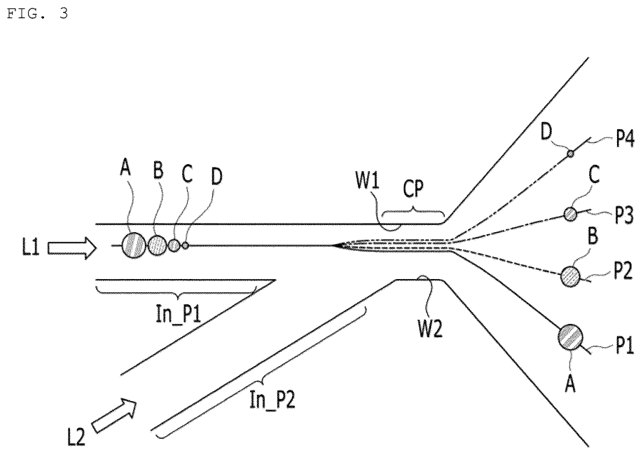

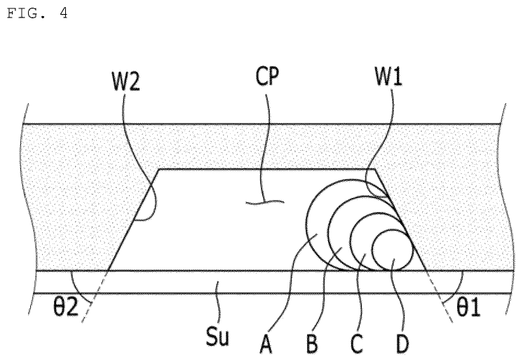

FIG. 1 illustrates a photograph of a particle separation device according to an embodiment of the present invention, and FIG. 2 is a plan view of a particle separation device according to an embodiment of the present invention. FIG. 3 is a drawing explaining the process of separating particles passing through a connecting flow path, and FIG. 4 is a cross-sectional view of a connecting flow path cut along III-III of FIG. 2.

Referring to FIGS. 1 to 4, a particle separation device according to an embodiment of the present invention may include an inflow path, a plurality of discharge paths, and a branch flow path, wherein the inflow path includes a first inflow path (In_P1) and a second inflow path (In_P2), and the inflow path may be connected to a plurality of discharge paths (EX1 to EX3) and a branch flow path (DP) through a connecting flow path (CP).

That is, the inflow path is composed of: a first inflow path through which a plurality of particles of different sizes from the first flow are mixed and introduced; a second inflow path through which a second fluid not including the particles is introduced; and a connecting flow path between the inflow path and the discharge path in which the first inflow path and the second inflow path are connected at one end and the other end is connected to the discharge path, and through which the third flow composed of the first flow and the second fluid moves.

According to this embodiment, a plurality of particles (A, B, C, D) passing through the connecting flow path (CP) connected to the first and second inflow paths (In_P1, In_P2) can be separated and discharged to a plurality of discharge paths (Ex) according to the size of the particles. At this time, the plurality of particles may be discharged with relatively smaller particles through the discharge path formed close to the inflow path, and with relatively larger particles through the discharge path formed far from the inflow path, based on the movement amount of the fluid.

In the present invention, the discharge path formed close to the inflow path based on the movement amount of the fluid means a flow path in a part where the movement amount of the fluid containing the particles is small based on the movement amount of the fluid, and in the case of the present invention, it means the uppermost discharge path (Ex1 of FIG. 2) based on FIG. 1 and FIG. 2. That is, in the case of the present invention, relatively small size of particles are discharged through the uppermost flow path, and the lower the discharge path, relatively larger size of particles can be discharged. At this time, the particles may be particles having a size of 10 nm to 20 μm, and in the present invention, particles having a small size, that is, particles having a size close to 10 nm, are discharged through the upper discharge path, and the lower the discharge path, particles having a larger size may be discharged. Additionally, particles that are not separated by size can be discharged through the discharge path or branch flow path at the bottom.

In addition, a portion of the fluid flowing out through the connecting flow path (CP) flows out through the branch flow path (DP), and by controlling the flow rate of the fluid flowing out through the branch flow path (DP), a plurality of particles can be controlled to be separated by particle size through a plurality of discharge paths (Ex).

Referring to FIG. 2, the first fluid (L1) can be injected through the first inflow path (In_P1). At this time, the first fluid (L1) may contain a plurality of particles of different sizes. That is, a first fluid (L1) containing a plurality of particles can be introduced into the first inflow path (In_P1). At this time, the first fluid can act as a type of carrier for moving a plurality of particles. In addition, a plurality of particles introduced through the first inflow path (In_P1) can be separated by particle size by passing through a particle separation device according to this embodiment. This will be described later.

At this time, the plurality of particles may be nanoparticles, microparticles, quantum dots, organelles, etc.

Here, nanoparticles refer to particles with a size of several nanometers, and microparticles refer to particles with a size of several micrometers. The particles applied to the particle separation device according to this embodiment may be various particles of several nanometers in size or several micrometers in size. In addition, the quantum dots represent semiconductor crystals of nanometer size manufactured through a chemical synthesis process. At this time, the quantum dots can emit light of various colors by generating light wavelengths of different lengths according to particle size without changing the type of material. Lastly, organelles refer to organelles that exist within a cell, and representative examples include the nucleus, mitochondria, and lysosomes. Most of these organelles have a spherical or sphere-like shape, so they can be distinguished in the same way as the nanoparticles discussed above, and since each has a different size, it is possible to separate each organelle by separating them according to size.

And, a second fluid (L2) that does not contain particles is injected into the second inflow path (In_P2). Unlike the first fluid (L1) described above, the second fluid (L2) consists only of liquid. That is, the first inflow path (In_P1) and the second inflow path (In_P2) are arranged at the inlet side of the particle separation device according to this embodiment. At this time, a plurality of particles of different sizes to be separated are injected into one inflow path, i.e., the first inflow path (In_P1), through the first fluid (L1), and the second fluid (L2) that does not contain particles is injected into the other inflow path, i.e., the second inflow path (In_P2). At this time, the second fluid may serve to add a moment to separate multiple nanoparticles included in the first fluid. The first fluid simply serves as a carrier to move the particles of the first fluid. At this time, if the second fluid is supplied in the direction of movement of the first fluid, a moment is applied to a plurality of particles inside the first fluid, and movement according to size can be exhibited (see FIG. 3).

At this time, the first fluid (L1) and the second fluid (L2) are preferably hydrophilic solvents, and may include, for example, any one of polyetheramine, an organic solvent including hexane and toluene, distilled water, an aqueous solution including Tween 20, saline, culture medium, and Phosphate Buffer Saline (PBS). For example, in this embodiment, a plurality of particles of different sizes can be included in the culture medium and injected into the first inflow path (In_P1).

The first inflow path (In_P1) and the second inflow path (In_P2) can be connected to a connecting flow path (CP). As shown in FIG. 2, the first inflow path (In_P1) and the second inflow path (In_P2) can be coupled to one end of the connecting flow path (CP).

At this time, the first inflow path (In_P1) and the second inflow path (In_P2) form a certain angle with each other and are connected to one end of the connecting flow path (CP). That is, the first inflow path (In_P1) and the second inflow path (In_P2) are arranged parallel to each other and are not coupled to one end of the connecting flow path (CP), and the second inflow path (In_P2) is coupled to the connecting flow path (CP) by being inclined at a certain angle with respect to the first inflow path (In_P1). Through this, as examined above, a certain moment can be applied to a plurality of particles included in the first fluid by using the second fluid.

For example, as shown in FIG. 2, the first inflow path (In_P1) is arranged parallel to the connecting flow path (CP) to supply a plurality of particles, but the second inflow path (In_P2) may be arranged at a certain angle with respect to the first inflow path (In_P2) to apply a moment from the side of the first fluid.

Looking at this in more detail, as illustrated in FIG. 3, when the first inflow path (In_P1) and the second inflow path (In_P2) form a certain angle with each other, a plurality of particles included in the first fluid (L1) can move along the first side (W1) of the connecting flow path (CP) by the supply of the second fluid. Here, the first side (W1) represents one side of the connecting flow path (CP) connected to the first inflow path (In_P1).

For example, the first flow (L1) passing through the first connecting flow path (In_P1) is slid along the first side (W1) of the connecting flow path (CP) by the second fluid (L2) and moves along the connecting flow path (CP).

At this time, if it is assumed that the first fluid (L1) contains a plurality of particles (A, B, C, D) of different sizes, particles of each size can be arranged on the first side according to their sizes. At the point where the first inflow path (In_P1) and the second inflow path (In_P2) meet, multiple particles (A, B, C, D) of the first fluid (L1) move toward the first side (W1) of the connecting flow path (CP) due to the pressure of the second fluid (L2) supplied through the second inflow path (In_P2). This is because the second fluid (L2) injected into the connecting flow path (CP) is injected at a certain angle with respect to the first fluid (L1). That is, the side of a plurality of particles (A, B, C, D) flowing into the connecting flow path (CP) is pressurized by the second fluid (L2) and a moment is generated, so that the plurality of particles slide and move along the first side (W1) of the connecting flow path (CP).

As described above, the first side (W1) of the connecting flow path (CP) can be arranged to be inclined at a first angle (θ1) with respect to the substrate (Su) (see FIG. 4). At this time, the first side (W1) is inclined toward the second side (W2) facing the first side (W1). Here, the second side (W2) represents one side of the connecting flow path (CP) connected to the second inflow path (In_P2). When the first side is formed by being inclined at a certain angle, as illustrated in FIG. 4, particles of each size can be positioned at a certain depth on the first side according to the supply of the second fluid. In addition, in the case of these particles, the point of contact with the first side is determined according to the size, so separation results can be obtained according to each size.

Looking into more detail, a plurality of particles (A, B, C, D) can be spaced apart from the first side (W1) in order of particle size. For example, particle (A), particle (B), particle (C), particle (D) can be spaced apart from the first side (W1) in the order of decreasing particle size (for convenience, it is assumed that particles (A, B, C, D) are spherical and the size of the particles is determined by the diameter of particles (A, B, C, D)). Finally, particles (A), (B), (C), and (D) in order of decreasing diameter size can be spaced apart from the first side (W1) and positioned at the center of the connecting flow path.

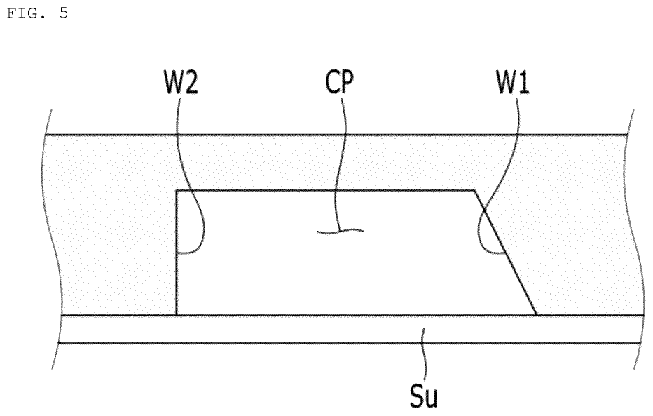

And, the second side (W2) may also be arranged to be inclined at a second angle (θ2) with respect to the substrate (Su). However, the present invention is not limited thereto, and the second side (W2) may be arranged perpendicularly with respect to the substrate (Su), as shown in the first modified example of FIG. 5. This is because a plurality of particles (A, B, C, D) move along the first side (W1) by the second fluid (L2) and do not move along the second side (W2).

At this time, the first angle (θ1) and the second angle (θ2) may be less than 90 degrees. Preferably, the first angle (θ1) and the second angle (θ2) may be 35 degrees to 55 degrees. In particular, when the first side (W1) is tilted at a first angle (θ1), particles included in the first fluid (L1) can be separated from the first side (W1) in order of particle size. If the above first angle is greater than 90 degrees, it is impossible to separate multiple particles according to size. In particular, when the first angle is less than 35 degrees, the angle of the first side may be too low, resulting in insufficient space within the passage, and thus the overall flow rate may decrease. In addition, when it exceeds 55 degrees, the change in position according to each size may decrease, resulting in a decrease in the separation efficiency of multiple particles.

That is, according to this embodiment, by tilting the first side (W1) toward the second side (W2), the distance between the particles (A, B, C, D) can be increased compared to the case where the first side (W1) is not tilted and is arranged vertically with respect to the substrate (Su). Here, the distance between the particles (A, B, C, D) means the distance between the centers of the particles (A, B, C, D).

At this time, the first side (W1) may be a flat plate shape. As shown in FIG. 4, the first side (W1) is formed in a flat plate shape, and a plurality of particles (A, B, C, D) are positioned within a connecting flow path (CP) while in contact with the substrate (Su) and the first side (W1), which is a flat plate.

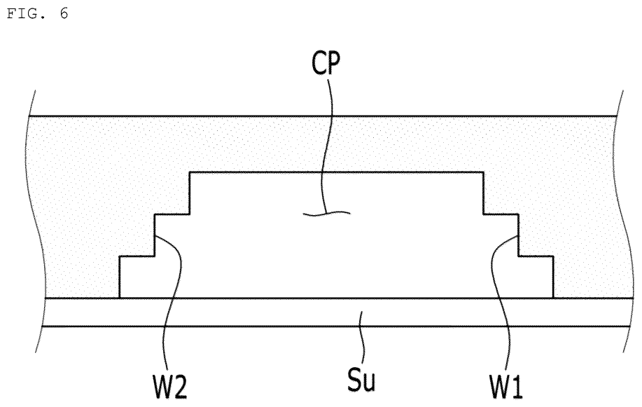

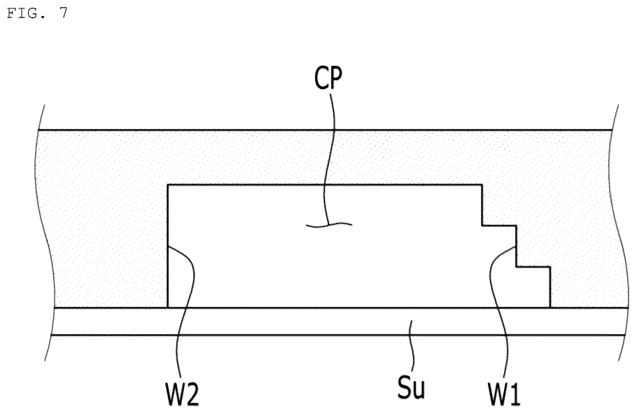

Meanwhile, the first side (W1) may be formed in a step shape as shown in the second modified example of FIG. 6. If the first side (W1) is formed in a step shape, the distance between multiple particles (A, B, C, D) can be further increased compared to when formed in a flat shape. At this time, as shown in FIG. 6, the second side (W2) may also have a step shape like the first side (W1), and as shown in FIG. 7, the second side may also have a simple vertical wall shape.

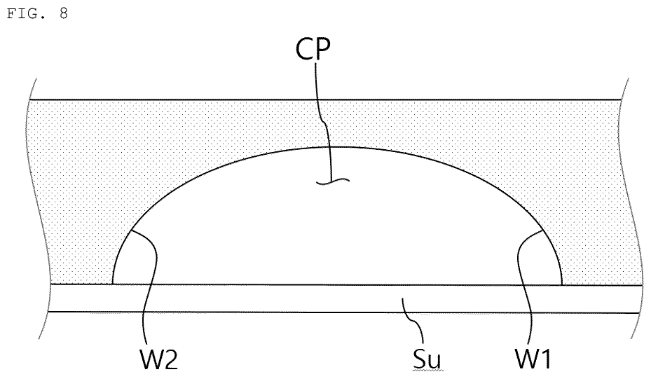

On the other hand, the first side may be arch-shaped (FIG. 8). It may be formed in a straight line as above, but it may also have an arch-shaped shape for convenience in manufacturing and processing. At this time, the first side (W1) may independently have an arch shape, but may also be manufactured in a shape that forms an arch by being connected to the second side (W2). That is, in this case, the interior of the flow path may also form a hemispherical arch.

Referring again to FIG. 1 and FIG. 2, multiple particles (A, B, C, D) are included in a third fluid (L3) consisting of a first fluid (L1) and a second fluid (L2) and pass through a connecting flow path (CP). As described above, multiple particles (A, B, C, D) slide and move along the first side (W1). Then, when they pass through the connecting passage (CP), they can move while being separated from each other by particle size, as shown in FIG. 3.

In addition, at this time, the first fluid (L1) and second fluid (L2) may be mixed to form a third fluid (L3), but due to the characteristics of the second fluid supplied from the side of the first fluid, they may not be mixed and form a laminar flow to form a third fluid, and it is also possible for only a portion to be mixed to form a third fluid.

In FIG. 3, multiple particles (A, B, C, D) slide along the first side (W1) by the second fluid (L2), and when they pass through the connecting passage (CP) by inertial force, they move obliquely toward the first side (W1).

At this time, particles (A, B, C, D) move along different paths depending on their sizes. Looking at it in more detail, each of the multiple particles (A, B, C, D) moves along paths (P1, P2, P3, P4). That is, particle (A) moves along path (P1), particle (B) moves along path (P2), particle (C) moves along path (P3), and particle (D) moves along path (P4).

Therefore, as shown in FIG. 3, the smaller the particle size, the more it can bend toward the first side (W1). That is, in the order of particle size, particle (D), particle (C), particle (B), and particle (A) can bend toward the first side (W1) the most.

Meanwhile, according to this embodiment, when the first side (W1) is tilted toward the second side (W2) as described above, the distance between the particles (A, B, C, D) increases, and thereby the distance between the paths (P1, P2, P3, P4) along which the particles (A, B, C, D) passing through the connecting flow path (CP) move increases. When the distance between a pair of adjacent paths among the paths (P1, P2, P3, P4) increases, the particles moving along the paths can be easily separated.

For example, looking at a particle (A) moving along a path (P1) and a particle (B) moving along a path (P2), the distance between the paths (P1) and (P2) increases more when the first side (W1) is tilted than when the first side (W1) is not tilted. This is because the first side (W1) is tilted, increasing the distance between the particle (A) and the particle (B) within the connecting flow path (CP).

Referring again to FIG. 2, a plurality of discharge paths (Ex) are arranged at the other end of the connecting flow path (CP). The plurality of discharge paths (Ex) can separate and discharge a plurality of particles discharged through the connecting flow path (CP) according to the size of the particles.

As described above, particles and fluids passing through the connecting flow path can be separated from each other according to their sizes and injected into multiple discharge paths (EX1 to EX3). At this time, multiple discharge paths (Ex) are arranged at the other end of the connecting flow path (CP). The multiple discharge paths (Ex) can separate and discharge multiple particles exiting the connecting flow path (CP) according to their sizes.

As described above, multiple discharge paths (Ex1, Ex2, Ex3) can be formed at the other end of the connecting flow path (CP). In FIG. 2, three discharge paths are described as being arranged, but the number of discharge paths is not limited thereto and may be less than or more than three. According to this embodiment, particles can be separately discharged into multiple discharge paths (Ex1, Ex2, Ex3) depending on their particle size, respectively.

At this time, the plurality of particles can be separated according to size, and this separation can be performed by the pressure and speed of the fluid. However, in the case of a separation chip such as the present invention, it can have hydraulic resistance (R) with respect to the fluid, and this hydraulic resistance can be connected to a pressure drop of the fluid. If the structure has high hydraulic resistance, a high pressure drop may occur, which may result in separation by size not being performed smoothly or particles not being discharged through the top discharge path (Ex1 in FIG. 2). In addition, if the hydraulic resistance is too low, all particles may be discharged through one discharge path, which may reduce the separation effect.

For the particle separation chip of the present invention, hydraulic resistance can be defined by the following Equation 1.

$$R = \frac{1}{1 - 0.63 ( \frac{h}{w} )} * \frac{12 μ L}{{h}^{3} w} \qquad [ Equation 1 ]$$

(wherein, R represents the hydraulic resistance, h represents the height of the discharge path, w represents the sum of the widths of the discharge paths, u represents the dynamic viscosity of the first fluid, and L represents the length of the path through which the particle passes, respectively.)

In the case of the present invention, since a lab-on-a-chip is used, the height (h), dynamic viscosity (u), and length (L) of the flow path can be kept constant. However, by changing the width of each discharge path, it is possible to design and manufacture under various conditions, and in this process, it is possible to manufacture a lab-on-a-chip having various hydraulic resistances. However, as examined above, only when the hydraulic resistance is within a certain range, the plurality of particles can be separated by size and discharged through each discharge path.

In the present invention, the hydraulic resistance (R) expressed by Equation 1 can be 6 to 10 E+12 Ns/m⁵.

If the above hydraulic resistance is less than 5.5 E+12 Ns/m⁵, the width of the discharge path must be excessively increased to form low hydraulic resistance, so not only cannot multiple discharge paths be formed, but also multiple particles may be discharged without being separated according to size due to excessive pressure. In addition, if the above hydraulic resistance exceeds 3.5 E+13 Ns/m⁵, a phenomenon may occur where the particles may not be separated due to excessive pressure drop and also may not be discharged through the uppermost discharge path.

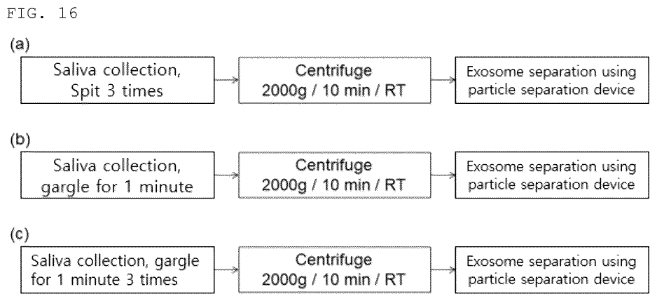

In addition, in order to form the hydraulic resistance as described above, the sum of the widths of the plurality of discharge paths may be 500 to 1100 μm, preferably 750 to 1000 μm, and more preferably 900 μm. As examined above, in the case of the present invention, the hydraulic resistance can be controlled by using the width of multiple discharge paths. That is, if the sum of the widths of the plurality of discharge paths increases, the hydraulic resistance decreases, and if the sum of the widths decreases, the hydraulic resistance may increase. Therefore, it is desirable that the sum of the discharge paths be within a certain range. If the sum of the above multiple discharge paths is less than 500 μm, high hydraulic resistance may occur, which may result in excessive pressure drop, and if it exceeds 1100 μm, excessive pressure must be continuously maintained, which may result in particle breakage or damage to the separation chip. In addition, as shown in FIG. 16, when the sum of the widths exceeds 500 μm, particle separation is confirmed in the discharge path direction, and only when the width is 750 μm or more, the particles are separated and discharged into the first discharge path and the second discharge path. Therefore, if the sum of the discharge path widths is less than 500 μm, particle separation may not be smooth due to excessive pressure drop. In addition, if the sum of the discharge path widths exceeds 1100, the width of the first discharge path becomes excessively wide, and particles may not be separated and may be discharged through the first discharge path.

Also, the Hagen-Poisson equation, which is re-expressed similarly to Ohm's law, is the following Equation 2.

$$P = RQ \qquad [ Equation 2 ]$$

(P is pressure, R is hydraulic resistance, Q is average flow rate)

At the same flow rate, the pressure differs by about 100 times depending on the R value, so if the hydraulic resistance is less than 6 E+12 Ns/m⁵, discharge through the top discharge path (Ex1) may not be possible, and separation by size may not be easy due to the low pressure.

In the above Equation 1, the h refers to the height of the discharge path, but since the channels of the lab-on-a-chip generally have the same or similar heights, the h may also be defined as the average height of the entire channel. In the present invention, the h may be 10 to 100 μm, and preferably 40 μm. If the h is less than 10 μm, the cross-sectional area is reduced, forming a high fluid resistance, which may make it difficult to discharge particles from the discharge path, and if the h exceeds 100 μm, it is inefficient because it is difficult to maintain the channel shape in a high-pressure section.

The μ is the dynamic viscosity of the first fluid, but in the case of the present invention, since the first fluid and the second fluid use the same material, the u may also be the dynamic viscosity of the first fluid, the second fluid, and the third fluid. At this time, the dynamic viscosity may have different values depending on each material, but in the case of the present invention, a material of 0.0001 to 0.005 Ns/m² can be used. The fluid used in the present invention may be a hydrophilic fluid. For example, an organic solvent including one of polyetheramine, hexane and toluene, distilled water, an aqueous solution including tween 20, saline, culture medium, and PBS (Phosphate Buffer Saline) may be used. These fluids have a dynamic viscosity within the above range, and substances having a similar dynamic viscosity can be separated using the lab-on-a-chip of the present invention. If the dynamic viscosity is less than 0.0001 Ns/m², the hydraulic resistance may be excessively reduced due to the low viscosity, making it difficult to separate the particles according to their size. If the dynamic viscosity exceeds 0.005 Ns/m², the high viscosity may cause a lot of hydraulic resistance, making it difficult to separate the particles.

The above L represents the length of the flow path, and the lab-on-a-chip of the present invention having the structure of FIG. 2 can have a flow path length of 10,000 to 20,000 μm, preferably 15, 450 μm. If the above flow path length is less than 10,000 μm, the movement path for particle alignment inside the lab-on-a-chip may be reduced, and sufficient separation may not be performed. If it exceeds 20,000 μm, the pressure drop due to hydraulic resistance may increase, and the separation efficiency may decrease.

In addition, by precisely controlling the hydraulic resistance in this way, it is possible to separate multiple particles with high efficiency when using the lab-on-a-chip of the present invention.

There are various methods used for particle separation in general. However, among the existing methods, physical methods such as centrifugation, filtering, and chromatography have very low separation efficiency (less than 10%), and chemical separation methods such as precipitation, magnetic particle attachment, and immunological separation methods can separate with high efficiency, but can cause deformation or damage to the particles themselves. However, in the case of the present invention, since a moment is applied to the particles and separation is performed according to the size of the particles, separation of the particles is possible with high efficiency while minimizing damage and deformation of the particles (separation efficiency of 90% or more).

A plurality of discharge paths (Ex1, Ex2, Ex3) can be arranged in a direction intersecting the flow direction of a third fluid (L3) coming from a connecting flow path (CP). That is, a plurality of discharge paths (Ex1, Ex2, Ex3) can be arranged spaced apart from each other in a direction intersecting the flow direction.

Looking at this in detail, as soon as the third flow exits the connecting flow path due to the supply moment of the second fluid, it moves upward (in the Ex1 direction in FIG. 2). At this time, since the multiple particles are arranged according to size, particles with smaller sizes (D) flow closer to the wall, and particles with larger sizes (A) flow closer to the center. In addition, in the case of the third fluid, since it rises upward and then moves in the direction of the lower separation flow path, the separation of the particles by size can be further accelerated according to inertia and centrifugal force. That is, in the case of a large particle (A), it is located in the center and has a relatively large volume and weight, so the amount of movement outward may be small, and in the case of a small particle (D), it has a relatively small volume and light weight, so the amount of movement outward may be large. At this time, since a discharge path is formed on the outer side, small particles (D) can be separated and discharged through the upper discharge path (e.g., Ex1), and large particles (A) can be separated and discharged through the lower discharge path (Ex3).

According to this embodiment, multiple discharge paths (Ex1, Ex2, Ex3) are arranged in the cross direction at equal intervals from each other. In more detail, the spacing between adjacent pairs of discharge paths (Ex1, Ex2, Ex3) is equal. For example, the gap between discharge path (Ex1) and discharge path (Ex2) and the gap between discharge path (Ex2) and discharge path (Ex3) are equal to each other. This can be equally applied not only when there are three discharge paths as shown in the drawing of the present invention, but also when there are multiple discharge paths. That is, the gap between discharge path (Ex2) and discharge path (Ex3) and the gap between discharge path (Ex3) and discharge path (Ex4) can be the same.

In the present invention, the plurality of discharge paths may include 2 to 5 discharge paths. In the case of existing inventions, multiple discharge paths are secured while reducing the width of the discharge path (approximately 10 μm), but in this case, the pressure drop increases and the fluid may not move smoothly. To improve this, a large amount of fluid can be discharged through the branch flow path, but this discharge through a large number of branch flow paths has the disadvantage that unseparated particles can be discharged through the branch flow paths.

Therefore, in the case of the present invention, it is preferable to include 2 to 5 discharge paths, preferably 3 discharge paths, and to make the sum of the discharge path widths 500 to 1000 μm as examined above. If the number of discharge paths is less than two, separation according to particle size cannot be performed, and if it exceeds five, pressure drop may occur due to the large number of discharge paths, and in addition, the total width of the discharge paths may be reduced to maintain the gap between each discharge path, which may increase the pressure drop.

Meanwhile, according to this embodiment, a branch flow path (DP), through which at least a portion of the third fluid (L3) coming out through the connecting flow path (CP), is discharged is arranged. The branch flow path (DP) is located at the outlet side of the connecting flow path (CP) and can be arranged adjacent to the plurality of discharge paths (Ex).

At this time, the branch flow path (DP) discharges a portion of the third fluid (L3) to the outside, so that multiple particles are separated and discharged to multiple discharge paths (Ex) corresponding to each particle size. When the branch flow path (DP) discharges a portion of the third fluid (L3) to the outside, the distance between the paths along which each of the aforementioned particles moves can increase. As a result, particles of different sizes can be easily separated by particle size.

According to this embodiment, the flow rate of the third fluid (L3) discharged through the branch flow path (DP) can be controlled. By controlling the flow rate of the third fluid (L3) discharged through the above branch flow path (DP), multiple particles discharged through the connecting flow path (CP) can be more easily separated and discharged according to particle size.

In the present invention, if the flow rate of the third fluid flowing out through the branch flow path (DP) is greater than a certain ratio with respect to the third fluid coming out through the connecting flow path (CP), particles can be easily separated. As the ratio of the flow rate of the third fluid flowing out through the branch flow path (DP) increases, the discharge path (Ex) through which the third fluid flowing out through the connecting flow path (CP) increases. For example, if the flow rate discharged into the branch flow path (DP) is 0% of the connecting flow path (CP), i.e., there is no flow rate discharged into the branch flow path (DP), the third fluid is discharged along one discharge path (Ex). On the other hand, as the ratio (%) of the flow rate discharged through the branch flow path (DP) increases, it can be seen that the number of discharge paths (Ex), which are the paths through which the third fluid is discharged, increases.

In particular, if the flow rate discharged into the branch flow path (DP) exceeds 99.5% of the connecting flow path (CP), the particles may not be separated and may be discharged into the branch flow path, which may lower the overall efficiency.

Meanwhile, according to this embodiment, the flow rate ratios of the first flow (L1) and the second flow (L2) flowing into the first inflow path (In_P1) and the second inflow path (In_P2) are different from each other. In particular, when the flow rate ratio of the first fluid (L1) and the second fluid (L2) is 0.1:99.9 to 50:50, multiple particles flowing out through the connecting flow path (CP) can be easily separated and discharged according to the size of the particles. More preferably, when the flow rate ratio of the first fluid (L1) and the second fluid (L2) is 5:95, multiple particles can be easily separated by particle size through multiple discharge paths. If the flow rate ratio of the first fluid and the second fluid is less than 0.1:99.9, the ratio of the second fluid becomes excessively high, thereby reducing the ratio of the first fluid, so that the amount of particles that can be injected decreases, which may lower the overall efficiency. If it exceeds 50:50, the ratio of the second fluid decreases, which may prevent sufficient moment from being transmitted to the particles. These insufficient moments can reduce the separation efficiency of each particle in the separator according to its size, and can reduce the separation efficiency of the particles.

Hereinafter, a particle separation method according to an embodiment of the present invention will be described. In describing the particle separation method of this embodiment, a detailed description of the same configuration as the particle separation device described above will be omitted.

Referring to FIG. 2, first, the first fluid (L1) is fed into the first inflow path (In_P1). At this time, the first fluid (L1) contains multiple particles of different sizes to be separated by particle size. That is, the first fluid (L1) containing multiple particles is fed through the first inflow path (In_P1).

Meanwhile, the second fluid (L2) that does not contain particles is introduced into the second inflow path (In_P2). Unlike the first fluid (L1) described above, the second fluid (L2) consists only of liquid.

That is, according to this embodiment, the first fluid (L1) containing particles and the second fluid (L2) not containing particles are injected into different inflow paths (In_P1, In_P2). At this time, the first fluid (L1) and the second fluid (L2) can be injected simultaneously, and also, for smooth movement of particles, the second fluid can be injected and then the first fluid can be injected.

At this time, the first inflow path (In_P1) and the second inflow path (In_P2) form a certain angle with each other and are connected to the inlet of the connecting flow path (CP). The first inflow path (In_P1) and the second inflow path (In_P2) are arranged parallel to each other and are not connected to one end of the connecting flow path (CP). That is, the second inflow path (In_P2) is tilted at a certain angle with respect to the first inflow path (In_P1) and connected to the connecting flow path (CP).

For example, as shown in FIG. 2, the first inflow path (In_P1) may be arranged parallel to the connecting flow path (CP), and the second inflow path (In_P2) may be arranged at a certain angle with respect to the first inflow path (In_P1). Through this, the second fluid supplied from the second flow path can apply a moment to a plurality of particles included in the first fluid, and due to this moment, the distance from the first side can be determined according to the size of the particles.

Meanwhile, according to this embodiment, the flow rate ratios of the first fluid (L1) and the second fluid (L2) flowing into the first inflow path (In_P1) and the second inflow path (In_P2) are different from each other. In particular, when the flow rate ratio of the first fluid (L1) and the second fluid (L2) is 0.1:99.9 to 50:50, multiple particles flowing out through the connecting flow path (CP) can be easily separated and discharged according to the size of the particles.

More preferably, when the flow rate ratio of the first fluid (L1) and the second fluid (L2) is 5:95, multiple particles can be easily separated by particle size through multiple discharge paths. Next, after the first fluid (L1) and the second fluid (L2) are input, the first fluid (L1) and the second fluid (L2) can flow into the connecting flow path (CP) after passing through the first inflow path (In_P1) and the second inflow path (In_P2), respectively.

Referring to FIG. 3, when the first inflow path (In_P1) and the second inflow path (In_P2) form a certain angle with each other, multiple particles included in the first fluid (L1) can be moved along the first side (W1) of the connecting flow path (CP) by the pressure of the second fluid. Here, the first side (W1) represents one side of the connecting flow path (CP) connected to the first inflow path (In_P1).

For example, it is assumed that a first fluid (L1) contains a plurality of particles (A, B, C, D) of different sizes. The first fluid (L1) passing through the first inflow path (In_P1) slides along the first side (W1) of the connecting flow path (CP) by the second fluid (L2) and moves along the connecting flow path (CP).

At the point where the first inflow path (In_P1) and the second inflow path (In_P2) meet, multiple particles (A, B, C, D) of the first fluid (L1) move toward the first side (W1) of the connecting flow path (CP) by the second fluid (L2) of the second inflow path (In_P2). This is because the second fluid (L2) introduced into the connecting flow path (CP) is introduced at a constant angle with respect to the first fluid (L1). That is, when a moment is transmitted to the plurality of particles by the supply of the second fluid (L2), the plurality of particles (A, B, C, D) introduced into the connecting flow path (CP) slide and move on the first side (W1) of the connecting flow path (CP).

As described above, as shown in FIG. 4, the first side (W1) of the connecting flow path (CP) can be arranged to be inclined at a first angle (θ1) with respect to the substrate (Su). At this time, it is desirable that the first side (W1) is tilted toward the second side (W2) facing the first side (W1). Here, the second side (W2) represents one side of the connecting flow path (CP) connected to the second inflow path (In_P2).

And, the second side (W2) may also be arranged to be inclined at a second angle (θ2) with respect to the substrate (Su). However, the present invention is not limited thereto, and the second side (W2) may also be arranged perpendicularly with respect to the substrate (Su), as shown in the first modified example of FIG. 5. This is because the plurality of particles (A, B, C, D) move along the first side (W1) by the second fluid (L2) and do not move along the second side (W2).

At this time, the first angle (θ1) and the second angle (θ2) may be less than 90 degrees. Preferably, the first angle (θ1) and the second angle (θ2) may be 35 degrees to 55 degrees. When the first side (W1) is tilted at a first angle (θ1), particles included in the first side (W1) can be separated from the first side (W1) in order of particle size.

Looking in more detail, multiple particles (A, B, C, D) can be spaced in order of particle size from the first side (W1). For example, particles (A), (B), (C), and (D) are spaced apart from the first side (W1) in the order of decreasing particle size. For convenience, particles (A, B, C, D) are assumed to be spherical, and the size of the particles is determined by the diameter of particles (A, B, C, D).

Finally, particles (A), (B), (C), and (D) can be separated from the first side (W1) in the order of decreasing diameter size.

According to this embodiment, by tilting the first side (W1) toward the second side (W2), the distance between the particles (A, B, C, D) can be increased compared to the case where the first side (W1) is not tilted and is arranged perpendicularly to the substrate (Su). Here, the distance between the particles (A, B, C, D) means the distance between the centers of the particles (A, B, C, D).

Next, particles (A, B, C, D) passing through the connecting flow path (CP) can be separated from each other according to particle size and injected into multiple discharge paths (EX1 to EX3). At this time, multiple discharge paths (Ex) are arranged at the other end of the connecting flow path (CP). Multiple discharge paths (Ex) can separate and discharge multiple particles discharged through the connecting flow path (CP) according to the size of the particles.

As described above, multiple discharge paths (Ex1, Ex2, Ex3) can be formed at the other end of the connecting flow path (CP). FIG. 2 illustrates that three discharge paths are arranged, but the number of discharge paths is not limited to this and may be less than or more than three. According to this embodiment, the particles can be separately discharged through multiple discharge paths (Ex1, Ex2, Ex3) depending on their particle size.

Meanwhile, according to this embodiment, at least a portion of the third fluid (L3) coming out through the connecting flow path (CP) can be discharged to the branch flow path (DP). The branch flow path (DP) is located at the outlet side of the connecting flow path (CP) and is arranged adjacent to the plurality of discharge paths (Ex).

The branch flow path (DP) discharges a portion of the third fluid (L3) to the outside, so that multiple particles are separated and discharged to multiple discharge paths (Ex) corresponding to each particle size. When the branch flow path (DP) discharges a portion of the third fluid (L3) to the outside, the distance between the paths along which each of the aforementioned particles moves can increase. As a result, particles of different sizes can be easily separated by particle size.

According to this embodiment, the flow rate of the third fluid (L3) discharged through the branch flow path (DP) can be controlled. By controlling the flow rate of the third fluid (L3) discharged through the above branch flow path (DP), multiple particles discharged through the connecting flow path (CP) can be more easily separated and discharged according to particle size.

The flow rate of the third fluid (L3) discharged through the branch flow path (DP) can be controlled. By controlling the flow rate of the third fluid (L3) discharged through the branch flow path (DP), multiple particles discharged through the connecting flow path (CP) can be more easily separated and discharged according to particle size.

For example, if the flow rate discharged into the branch flow path (DP) is 0% of the connecting flow path (CP), i.e., there is no flow rate discharged into the branch flow path (DP), the third fluid is discharged along one discharge path (Ex). On the other hand, as the ratio (%) of the flow rate discharged through the branch flow path (DP) increases, it can be seen that the number of discharge paths (Ex), which are the paths through which the third flow is discharged, increases.

In particular, when the flow rate discharged to the branch flow path (DP) is 0% to 99.9%, preferably 0% to 97.5%, of the connecting flow path (CP), it can be seen that the number of discharge paths (Ex), which are paths through which the third fluid is discharged, is maximized. In a particle separation device and a particle separation method according to an embodiment of the present invention, a branch flow path (DP) is arranged at the outlet side of the connecting flow path (CP) to discharge a portion of a fluid flowing out through the connecting flow path (CP), so that a plurality of particles discharged through the connecting flow path (CP) can be easily separated by particle size.

Meanwhile, according to the particle separation device and a particle separation method of this embodiment, micro particles and nano particles can be separated from each other, and nano particles of different sizes can also be separated from each other.

In addition, this embodiment can be applied to a non-destructive high-efficiency exosome precision separation system, a blood analysis chip, a DNA array, a micro sensor, or a precision separation system, and as an example, it can be used for the analysis of saliva, sweat, tears, nasal mucus, or seminal plasma.

The present invention also relates to a particle separation device including: an inflow path through which one or more types of fluids are introduced; a plurality of discharge paths through which a plurality of particles included in the fluid introduced through the inflow path are separated and discharged according to their sizes; and a branch flow path through which a portion of the one or more types of fluids are discharged, wherein the particle separation device has a hydraulic resistance (R) of 6 to 10 E+12 Ns/m⁵, as expressed by the following Equation 1.

$$R = \frac{1}{1 - 0.63 ( \frac{h}{w} )} * \frac{12 μ L}{{h}^{3} w} \qquad [ Equation 1 ]$$

(wherein, R represents the hydraulic resistance, h represents the height of the discharge path, w represents the sum of the widths of the discharge paths, u represents the dynamic viscosity of the first fluid, and L represents the length of the path through which the particle passes, respectively.)

The present invention also relates to a particle separation method by size using a particle separation device, wherein the particle separation device includes: an inflow path through which one or more types of fluids are introduced; a plurality of discharge paths through which a plurality of particles included in the fluid introduced through the inflow path are separated and discharged according to their sizes; and a branch flow path through which a portion of the one or more types of fluids are discharged, wherein the discharge path formed close to the inflow path based on the movement amount of the fluid discharges particles of relatively small sizes, and the discharge path formed far from the inflow path discharges particles of relatively large sizes.

The above particle separation method may include the following steps of: supplying particles and a first fluid mixture through the first path among the inflow paths; supplying a second fluid through the second path among the inflow paths; discharging particles separated by size through the discharge path, respectively; and discharging excess fluid through the branch flow path.

In addition, the particle separation device and particle separation method of the present invention can be used to separate particles such as exosomes from human secretions such as saliva, blood, urine, sweat, and breast milk.

When the above particle separation device is used in a method for separating exosomes from saliva, the present invention can provide a method for separating and pretreating exosomes from saliva, including the following steps of: (a) collecting saliva from a test subject; (b) centrifuging the collected saliva to separate and concentrate cellular material; and (c) classifying the cellular material according to size to obtain desired bioparticles.

The step (a) above may include: i) a step of the subject spitting saliva into a collection container to collect saliva; or ii) a step of the subject gargling with a collection gargle solution and then spitting the gargle solution into a collection container to collect saliva (see FIG. 16).

The step i) or the above step ii) can be performed repeatedly 1 to 5 times.

The step (c) can be performed using the particle separation device.

In the present invention, the cellular material refers to cellular particles contained in the saliva, and in the present invention, “cellular material” and “particle” may be used interchangeably.

The present invention also provides a device for separating and pretreating exosomes from saliva, including: an inflow path through which one or more fluids including saliva are introduced; a plurality of discharge paths through which a plurality of cellular substances included in the fluid introduced through the inflow path are separated and discharged according to their sizes; and a branch flow path through which a portion of one or more fluids including saliva is discharged, wherein the cellular substances are bioparticles including exosomes, and the hydraulic resistance (R) expressed by the following Equation 1 is 6 to 10 E+12 Ns/m⁵.

$$R = \frac{1}{1 - 0.63 ( \frac{h}{w} )} * \frac{12 μ L}{{h}^{3} w} \qquad [ Equation 1 ]$$

(wherein, R represents the hydraulic resistance, h represents the height of the discharge path, w represents the sum of the widths of the discharge paths, u represents the dynamic viscosity of the first fluid, and L represents the length of the path through which the particle passes, respectively.)

In addition, when used to separate exosomes from urine, the present invention provides a device for separating particles from urine, including: a centrifuge for separating cells and foreign substances from urine; and a particle separation device for separating exosomes from urine from which cells and foreign substances have been separated, wherein the particle separation device includes: an inflow path through which one or more fluids including urine is introduced; a plurality of discharge paths through which a plurality of cellular substances included in the fluids introduced through the inflow path are separated and discharged according to their sizes; and a branch flow path through which a portion of one or more fluids are discharged, wherein the cellular substances are bioparticles including exosomes, and based on the movement amount of the fluid, the discharge path formed close to the inflow path discharges cellular substances of relatively small sizes, and the discharge path formed far from the inflow path discharges cellular substances of relatively large sizes.

The present invention also provides a device for separating particles from urine, including: a centrifuge for separating cells and foreign substances from urine; and a particle separation device for separating exosomes from urine from which cells and foreign substances have been separated, wherein the particle separation device includes: an inflow path through which one or more fluids including urine is introduced; a plurality of discharge paths through which a plurality of cellular substances included in the fluids introduced through the inflow path are separated and discharged according to their sizes; and a branch flow path through which a portion of one or more fluids are discharged, wherein the cellular substances are bioparticles including exosomes, and the particle separation device has a hydraulic resistance (R) expressed by the following Equation 1 of 6 to 10 E+12 Ns/m⁵.

$$R = \frac{1}{1 - 0.63 ( \frac{h}{w} )} * \frac{12 μ L}{{h}^{3} w} \qquad [ Equation 1 ]$$

(wherein, R represents the hydraulic resistance, h represents the height of the discharge path, w represents the sum of the widths of the discharge paths, u represents the dynamic viscosity of the first fluid, and L represents the length of the path through which the particle passes, respectively.)

The present invention also provides a method for separating particles using a device for separating particles from urine, wherein the device for separating particles from urine includes: a centrifuge for separating cells and foreign substances from urine; and a particle separation device for separating exosomes from urine from which cells and foreign substances have been separated, wherein the particle separation device includes: an inflow path through which one or more fluids including urine is introduced; a plurality of discharge paths through which a plurality of cellular substances included in the fluids introduced through the inflow path are separated and discharged according to their sizes; and a branch flow path through which a portion of one or more fluids are discharged, wherein based on the movement amount of the fluid, the discharge path formed close to the inflow path discharges cellular substances of relatively small sizes, and the discharge path formed far from the inflow path discharges cellular substances of relatively large sizes.

The method for separating particles from the urine includes the steps of: supplying a first fluid containing urine through a first flow path among the inflow paths; supplying a second fluid through a second flow path among the inflow paths; discharging cellular substances separated by size through a discharge path; and discharging excess fluid through a branch flow path, wherein the cellular substances may include exosomes.

Hereinafter, preferred examples of the present invention will be described with reference to the attached drawings so that those skilled in the art can easily practice it. In addition, when describing the present invention, if it is judged that a specific description of a related known function or known configuration may unnecessarily obscure the gist of the present invention, the detailed description thereof will be omitted. In addition, some features presented in the drawings are enlarged or reduced or simplified for ease of explanation, and the drawings and their components are not necessarily drawn in an appropriate ratio. However, those skilled in the art will easily understand these details.

### Examples 1 to 4

Since there are limitations in actually manufacturing and testing flow paths of all shapes, a particle separation device with three discharge paths and a particle separation device with nine discharge paths were first manufactured (see FIG. 1 and FIG. 2) and compared with the simulation data.

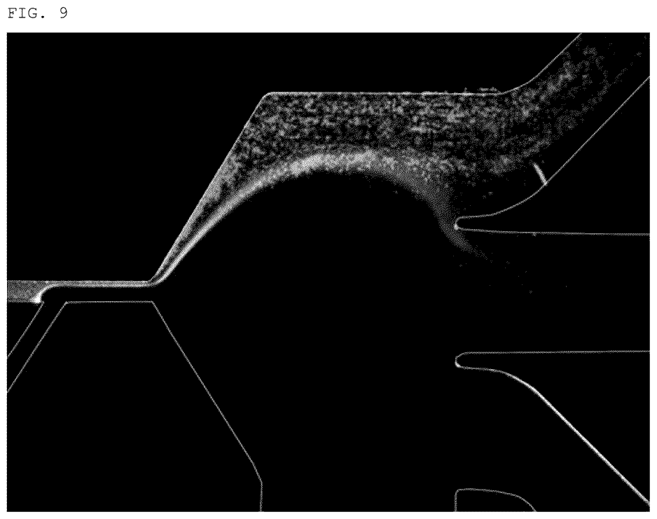

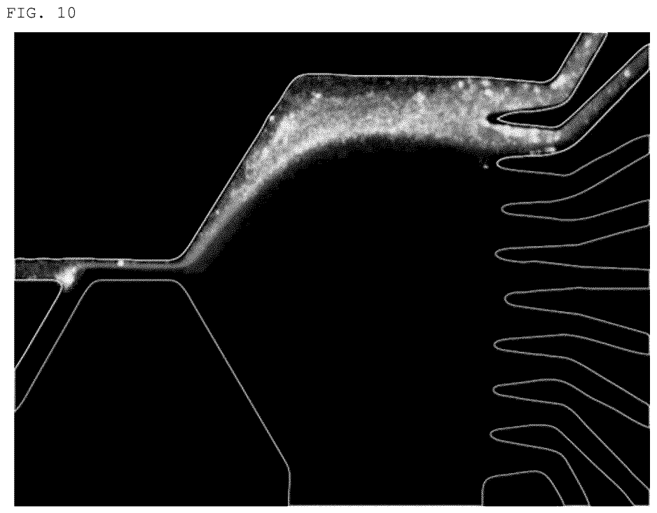

For Example 1, it is a particle separation device with three discharge paths as shown in FIG. 9, and for Example 2, it is a particle separation device with nine discharge paths (FIG. 10).

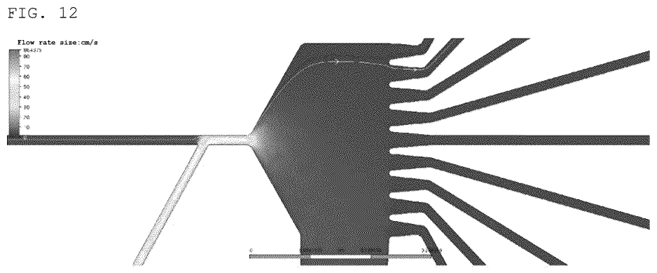

Example 3 is simulation data with the same conditions as Example 1, and Example 4 is simulation data (FIG. 12) with the same conditions as Example 2.

The height of each flow path was set to 40 μm, and the length of the entire flow path was set to 15450 μm. Each discharge path was set to have a width of 300 μm, and since there were three discharge paths, the sum of the discharge path widths was set to 900 μm.

### Test Example 1

The flow rate of the first fluid was set to 5 μl/min, and the flow rate of the second fluid was set to 95 μl/min. The flow rate discharged from the branch flow path was set to 75 μl/min, and then the experiment was conducted by mixing the same weight of particles of 100 nm size and 600 nm size in the first fluid at a ratio of 1 wt %.

At this time, green fluorescent particles were used for particles of 100 nm in size, and red fluorescent particles were used for particles of 600 nm in size. In addition, fluorescent particles were used to effectively confirm the behavior, and the background was made black.

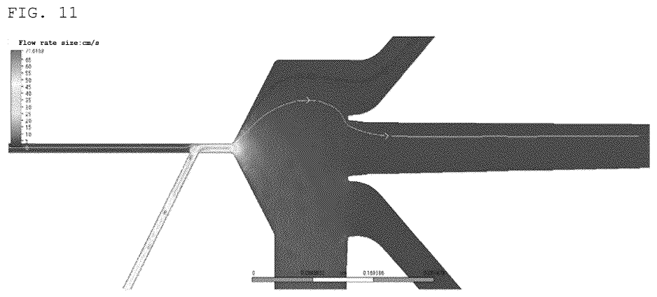

As illustrated in FIG. 9 and FIG. 11, it was confirmed that the actual experiment and simulation data matched in the case of three discharge paths, and as shown in FIG. 10 and FIG. 12, it was confirmed that the simulation data and actual experiment matched even in the case of nine discharge paths.

In the subsequent experiments, simulation experiments were performed based on the above data.

### Examples 5 to 13

An experiment was conducted to confirm the separation efficiency and discharge pressure according to the number of discharge paths. In order to visualize it specifically, a simulation experiment method using Ansys was used. A particle separation device was manufactured as shown in FIG. 1. At this time, the height of each flow path was set to 40 μm, and the length of the entire flow path was set to 15450 μm.

The sum of the total discharge paths was set to 900 μm, the same as in Examples 1 and 2 above, and Examples 5 to 13 were prepared so that each discharge path had 1 to 9.

### Test Example 2

An experiment was conducted by mixing particles having a size of 100 nm and particles having a size of 600 nm at the same mixing ratio and then mixing them in the first fluid at a ratio of 1 wt %. At this time, as shown in FIG. 11, the flow rate of the first fluid was set to 5 μl/min and the flow rate of the second fluid was set to 95 μl/min. When the flow rate discharged from the branch flow path was set to 75 μl/min, the pressure of the first fluid, the second fluid, and the pressure of the branch flow path for normal operation were measured, and the pressure (dyne/cm²) and hydraulic resistance (E+12 Ns/m⁵) of each flow path according to the number (units) of discharge paths and the sum of the flow path widths (μm) were measured.

TABLE 1

| | Num- | Path | First | Second | Branch | Hydraulic |
|---|---|---|---|---|---|---|
| | ber | width | fluid | fluid | flow path | resistance |
| Example | 1 | 900 | 117,866 | 2,017,690 | 232,956 | 4.5495 |
| 5 | | | | | | |
| Example | 2 | 900 | 123,776 | 2,026,080 | 229, 907 | 5.4498 |
| 6 | | | | | | |
| Example | 3 | 900 | 55,000 | 552,200 | 191,000 | 9.5887 |
| 7 | | | | | | |
| Example | 4 | 900 | 126,010 | 2,019,070 | 227,305 | 11.4658 |
| 8 | | | | | | |
| Example | 5 | 900 | 134,534 | 2,041,067 | 220,140 | 11.9957 |
| 9 | | | | | | |
| Example | 6 | 900 | 82,184 | 1,194,558 | 141,377 | 13.4465 |
| 10 | | | | | | |
| Example | 7 | 900 | 135,036 | 1,953,115 | 216,423 | 14.3486 |
| 11 | | | | | | |
| Example | 8 | 900 | 139,714 | 1,993,418 | 213,680 | 14.9668 |
| 12 | | | | | | |
| Example | 9 | 900 | 130,168 | 2,025,800 | 180,680 | 15.1942 |
| 13 | | | | | | |

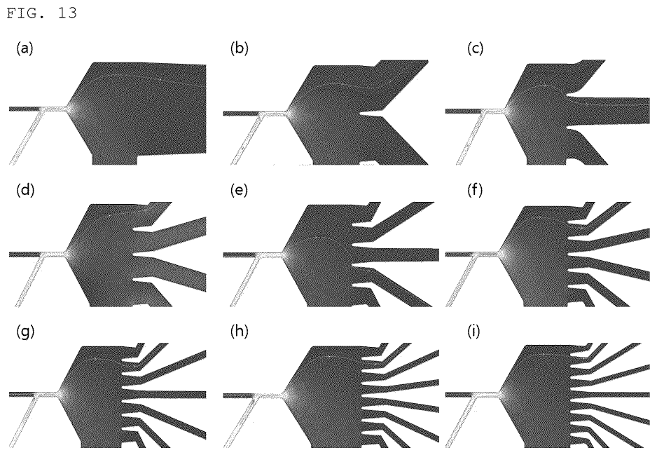

As shown in FIG. 13, when the first fluid and the second fluid were supplied at the pressures described in Table 1 above and the fluid was discharged through the branch flow path, it was confirmed that the particles were properly separated. However, as shown in Table 1, in the case of Example 7 of the present invention, that is, when there were three discharge paths, it was confirmed that normal operation was possible even with the lowest pressure (FIG. 13C).

This is because when there are three flow paths, that is, when the hydraulic resistance is 6 to 10 E+12 Ns/m⁵, the separation of particles contained in the fluid occurs easily as the resistance value is appropriate. When the hydraulic resistance is lower than this (Example 5, 6, FIG. 13A, 13B), even when an appropriate amount is discharged from the branch flow path, the amount of fluid discharged through the discharge path increases, so the first fluid and second fluid must be supplied at a higher pressure to maintain an appropriate internal pressure. Also, in cases where the hydraulic resistance is higher than that of Example 7 (Examples 8 to 13, FIG. 13D to 13I), that is, when the number of discharge paths is 4 to 9, the flow rate decreases as the internal work force increases, and it was found that the supply pressures of the first fluid and the second fluid must be increased to secure appropriate flow rate and velocity for normal operation. In the following Examples, experiments were conducted to optimize Example 7, which has 3 flow paths.

### Examples 14 to 19

In the above Test Example 2, it was confirmed that the driving pressure was the lowest when there were three discharge paths. Below, the separation efficiency according to each flow path width was confirmed based on three discharge paths. Each discharge path was numbered from the top, and the ratio of particles discharged from each discharge path was measured. The weight ratio of particles discharged from each flow path according to the number of discharge paths (units) and the sum of the flow path widths (μm) is shown in Table 2 below.

TABLE 2

| | Num- | Flow Path | 1 | | 2 | | 3 | |
|---|---|---|---|---|---|---|---|---|
| | ber | width | 100 | 600 | 100 | 600 | 100 | 600 |
| Example 14 | 3 | 150 | 0 | 0 | 61 | 62 | 23 | 31 |
| Example 15 | 3 | 300 | 1 | 0 | 64 | 62 | 25 | 29 |
| Example 16 | 3 | 450 | 8 | 0 | 65 | 66 | 24 | 28 |
| Example 17 | 3 | 600 | 14 | 0 | 64 | 72 | 21 | 26 |
| Example 18 | 3 | 750 | 37 | 1 | 45 | 63 | 16 | 25 |
| Example 19 | 3 | 900 | 91 | 6 | 5 | 93 | 3 | 1 |
| Example 20 | 3 | 1100 | 97 | 32 | 1 | 60 | 1 | 0 |
| Example 21 | 3 | 1300 | 99 | 75 | 0 | 25 | 0 | 0 |

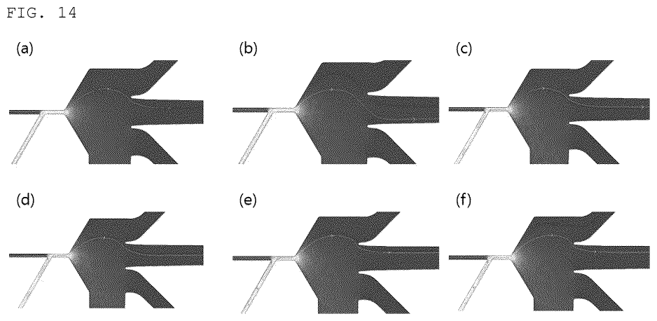

As shown in Table 2, when the sum of the flow path widths was 900 μm (Example 19, FIG. 14F), a separation efficiency of over 90% was achieved. In addition, as shown in Examples 17 and 18 (FIGS. 14D, 14E), it was confirmed that particles with a size of 100 nm could be separated with high purity in the first flow path when the flow path width was reduced. However, when the sum of the flow path widths is less than 500 μm (Example 16, FIG. 14C), it was confirmed that the separation efficiency decreases rapidly, and in particular, the ratio discharged to the third flow path also decreases, confirming that particles are lost to the branch flow path. That is, in the case of the present invention, the maximum separation efficiency can be achieved only when there are three flow paths and the sum of the flow path widths is 500 μm or more, and when it is less than 500 μm, the separation efficiency is found to decrease rapidly.

In addition, when the sum of the flow path widths was set to 1100 μm, it was confirmed that particles of 600 nm in size were separated with high purity in the second flow path. However, when it exceeded 1300 μm, it was confirmed that the amount of particles discharged without being separated from the first flow path increased, so the separation efficiency decreased.

### Test Example 2

An actual particle separation experiment was performed using Examples 5 to 13 above. 100 nm particles and 600 nm particles were mixed in the same weight ratio, and then the experiment was performed by mixing them in the first fluid at a ratio of 1 wt %. The remaining conditions were the same as Test Example 1. Each discharge path was numbered from the top, and the ratio of particles discharged from each discharge path was measured. If the ratio exceeded 80%, the largest amount of particles (100 or 600) was described. A discharge path that was mixed at a ratio of less than 80% and discharged was marked as “mixed.”

TABLE 3

| | Discharge path | | | | | | | | |
|---|---|---|---|---|---|---|---|---|---|
| | 1 | 2 | 3 | 4 | 5 | 6 | 7 | 8 | 9 |
| Example | Mixed | — | — | — | — | — | — | — | — |
| 5 | | | | | | | | | |
| Example | Mixed | Mixed | — | — | — | — | — | — | — |
| 6 | | | | | | | | | |
| Example | 100 | 600 | Mixed | — | — | — | — | — | — |
| 7 | | | | | | | | | |
| Example | 100 | Mixed | 600 | Mixed | — | — | — | — | — |
| 8 | | | | | | | | | |
| Example | — | 100 | Mixed | 600 | Mixed | — | — | — | — |
| 9 | | | | | | | | | |
| Example | — | 100 | Mixed | 600 | Mixed | Mixed | — | — | — |
| 10 | | | | | | | | | |
| Example | 100 | Mixed | 600 | 600 | Mixed | Mixed | Mixed | — | — |
| 11 | | | | | | | | | |
| Example | — | 100 | Mixed | Mixed | Mixed | 600 | 600 | Mixed | — |
| 12 | | | | | | | | | |
| Example | — | — | 100 | Mixed | Mixed | Mixed | Mixed | 600 | Mixed |
| 13 | | | | | | | | | |

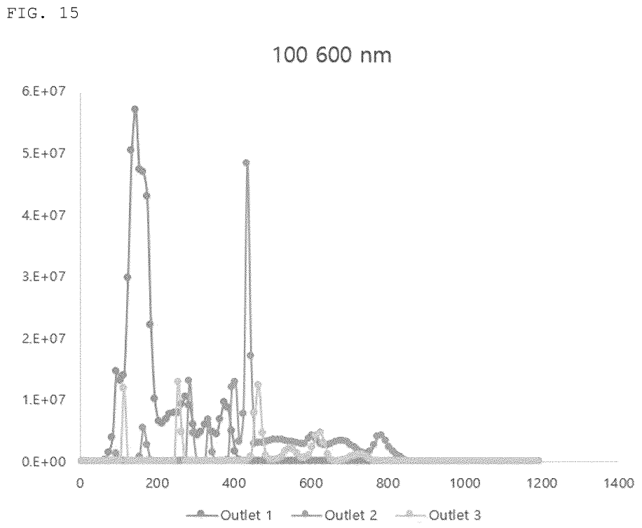

As shown in Table 3, in the case of Example 7 of the present invention, particles of 100 nm and 600 nm were properly separated, and it was confirmed that the remaining particles were discharged through the third discharge path (see FIG. 15). For Examples 5 and 6, which have 1 and 2 discharge paths, it was confirmed that the particles could not be discharged separately, so they were discharged in a mixed state. In addition, for Examples 8 to 13, which have 4 or more discharge paths, although separated particles were discharged in some discharge paths, it was confirmed that mixed particles were discharged in most flow paths, so the efficiency was very low.

When combining this with Test Example 1, it was confirmed that it can have the highest possible efficiency when it has three discharge paths and a hydraulic resistance of 6 to 10 E+12 Ns/m⁵.

### Test Example 3

It was verified whether the particle separation device of the present invention can be used to separate exosomes and peptides from saliva.

The subject gargled with the gargle solution for collection, then spat the gargle solution into a collection container to collect saliva. The collected saliva was centrifuged at 2000G for 10 minutes to remove cellular material and cell debris. For comparison, normal subjects (Example 22) and patients with xerostomia (Example 23) were selected and the experiment was conducted.

Afterwards, it was confirmed whether separation of exosomes (average size 100 μm) was possible using the same particle separation device as in Example 19 above.

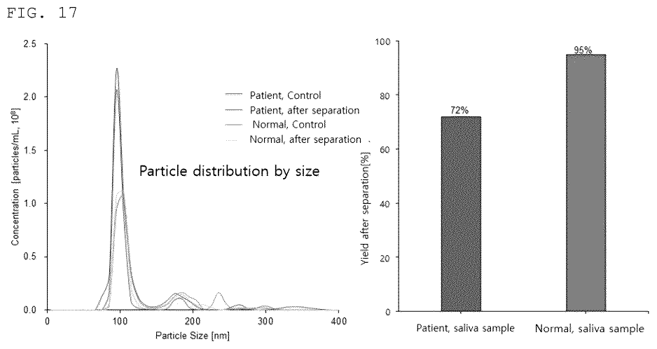

As shown in FIG. 17, both samples of Examples 22 and 23 confirmed that large particles were normally removed. In particular, when the particle separation device of the present invention was used, it was confirmed that exosomes could be separated at a high rate of 95% for normal subjects and 72% for patients with xerostomia.

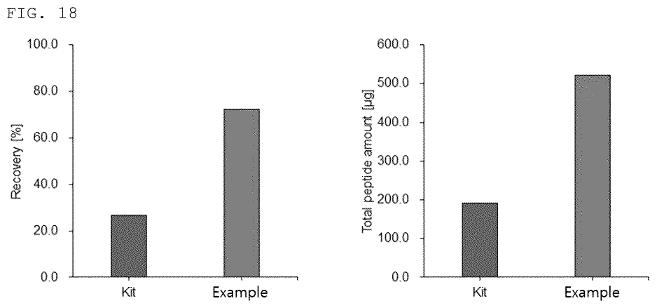

In addition, in order to verify the effectiveness of the particle separation device of the present invention, an experiment was conducted to separate peptides from saliva in Example 23. As shown in FIG. 18, when a conventional peptide separation kit (manufactured by Core Science) was used, the separation efficiency was confirmed to be approximately 30%, but when the particle separation device of the present invention was used, the separation efficiency was confirmed to increase to 70%.

### Test Example 4

An experiment was conducted to confirm the separation efficiency when using the separation device of Example 19 above to separate exosomes from actual urine.

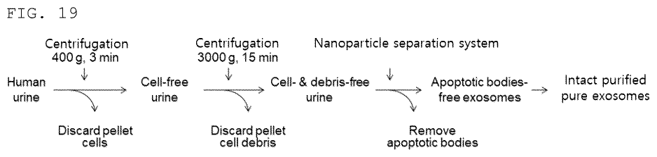

Urine samples were collected from a healthy subject (Example 24), a patient with glomerulonephritis (Example 25), and a patient with preeclampsia (Example 26), and centrifuged at 400 G for 3 minutes to remove cellular material. The urine from which cellular material had been removed was centrifuged at 3000 G for 15 minutes to remove cellular debris (FIG. 19).

Afterwards, it was confirmed whether separation of exosomes (average size 150 μm) was possible using the same particle separation device as in Example 19 above.

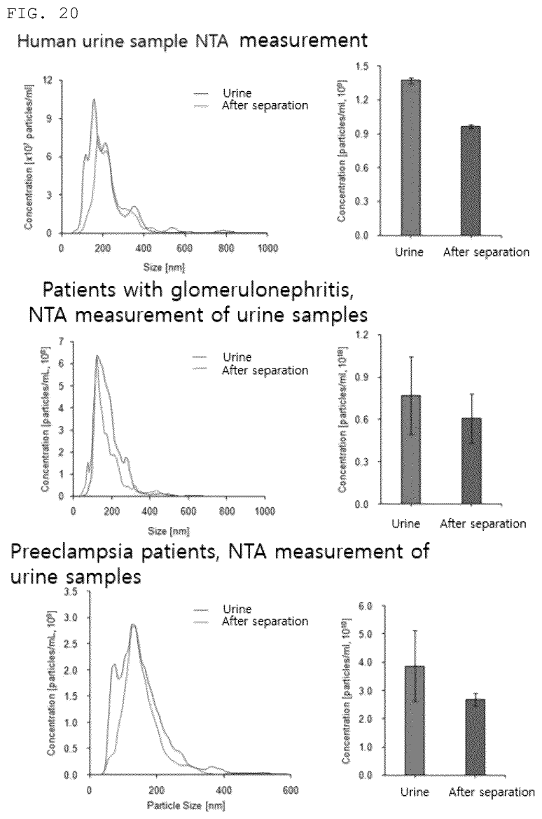

As shown in FIG. 20, it was confirmed that large particles were normally removed in all samples of Examples 24, 25, and 26.

For comparison with existing separation methods, the separation results (BEST) of Example 26, Ultracentrifugation (UC), and Precipitation results were displayed in one graph.

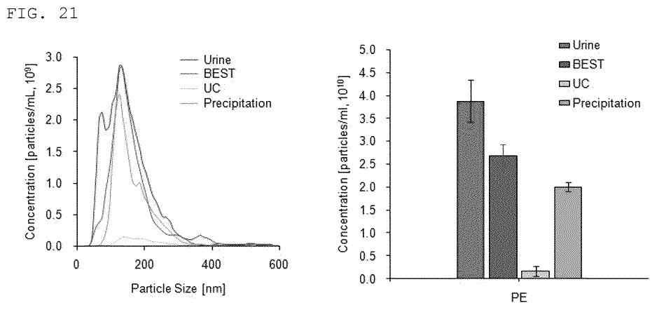

As shown in FIG. 21, in the case of Example 26 of the present invention, it was shown that exosome separation was possible at a high rate, and the separation efficiency was also confirmed to be superior to the existing UC and Precipitation.

While the specific parts of the present invention have been described in detail above, it will be apparent to those skilled in the art that such specific descriptions are merely preferred embodiments and that the scope of the present invention is not limited thereby. Accordingly, the actual scope of the present invention will be defined by the appended claims and their equivalents.

1. A particle separation device, comprising:
an inflow path through which one or more types of fluids are introduced;
a plurality of discharge paths through which a plurality of particles included in the fluid introduced through the inflow path are separated and discharged according to their sizes; and
a branch flow path through which a portion of the one or more types of fluids are discharged,
wherein the discharge path formed close to the inflow path based on the movement amount of the fluid discharges particles of relatively small sizes, and the discharge path formed far from the inflow path discharges particles of relatively large sizes.

2. The particle separation device of claim 1, which has a hydraulic resistance (R) of 6 to 10 E+12 Ns/m⁵, as expressed by the following Equation 1.
$$R = \frac{1}{1 - 0.63 ( \frac{h}{w} )} * \frac{12 μ L}{{h}^{3} w} \qquad [ Equation 1 ]$$
(wherein, R represents the hydraulic resistance, h represents the height of the discharge path, w represents the sum of the widths of the discharge paths, u represents the dynamic viscosity of the first fluid, and L represents the length of the path through which the particle passes, respectively.)

3. The particle separation device of claim 2, wherein the sum of the widths of the plurality of discharge paths is 500 to 1100 μm.

4. The particle separation device of claim 1, wherein the inflow path is composed of:
a first inflow path through which a plurality of particles of different sizes from the first fluid are mixed and introduced;
a second inflow path through which a second fluid not including the particles is introduced; and
a connecting flow path between the inflow path and the discharge path, in which the first inflow path and the second inflow path are connected at one end and the other end is connected to the discharge path, and through which the third fluid composed of the first flow and the second fluid moves.

5. The particle separation device of claim 4, wherein the connecting flow path comprises:
a substrate;
a first side formed on the substrate and connected to the first inflow path; and
a second side facing the first side on the substrate and connected to the second inflow path.

6. The particle separation device of claim 5, wherein the plurality of particles are moved by sliding on the first side.

7. The particle separation device of claim 6, wherein the first side is inclined toward the second side with respect to the substrate.

8. The particle separation device of claim 7, wherein the first side has a flat shape, a step shape, or an arch shape.

9. The particle separation device of claim 1, wherein the plurality of discharge paths are spaced apart from each other on the other end side of the connecting flow path in a direction intersecting with the flow direction of the third fluid.

10. The particle separation device of claim 1, wherein the flow rate ratio of the first fluid and the second fluid flowing into the first inflow path and the second inflow path, respectively, is 0.1:99.9 to 50:50.

11. The particle separation device of claim 1, wherein the flow rate of the third fluid discharged through the branch flow path is 0% to 99.9% of the flow rate of the third fluid discharged through the connecting flow path.

12. The particle separation device of claim 1, wherein the second inflow path is inclined at a predetermined angle with respect to the first inflow path.

13. A particle separation device, comprising:
an inflow path through which one or more types of fluids are introduced;
a plurality of discharge paths through which a plurality of particles included in the fluid introduced through the inflow path are separated and discharged according to their sizes; and
a branch flow path through which a portion of the one or more types of fluids are discharged,
wherein the particle separation device has a hydraulic resistance (R) of 6 to 10 E+12 Ns/m⁵, as expressed by the following Equation 1.
$$R = \frac{1}{1 - 0.63 ( \frac{h}{w} )} * \frac{12 μ L}{{h}^{3} w} \qquad [ Equation 1 ]$$
(wherein, R represents the hydraulic resistance, h represents the height of the discharge path, w represents the sum of the widths of the discharge paths, μ represents the dynamic viscosity of the first fluid, and L represents the length of the path through which the particle passes, respectively.)

14. A particle separation method by size using a particle separation device, wherein the particle separation device comprises: an inflow path through which one or more types of fluids are introduced; a plurality of discharge paths through which a plurality of particles included in the fluid introduced through the inflow path are separated and discharged according to their sizes; and a branch flow path through which a portion of the one or more types of fluids are discharged,
wherein the discharge path formed close to the inflow path based on the movement amount of the fluid discharges particles of relatively small sizes, and the discharge path formed far from the inflow path discharges particles of relatively large sizes.

15. The particle separation method of claim 14, which comprises the following steps of:
supplying particles and a first fluid mixture through a first path among the inflow paths;
supplying a second fluid through a second path among the inflow paths;
discharging particles separated by size through a discharge path, respectively; and
discharging excess fluid through the branch flow path.
